(19) United States
(12) Patent Application Publication
(10) Pub. No.: US 2023/0211664 A1
(43) Pub. Date: Jul. 6, 2023

(54) ELECTRIC VEHICLE CHARGING MANAGEMENT SYSTEM

(71) Applicant: Kwang Yang Motor Co., Ltd., Kaohsiung (TW)

(72) Inventor: Hao-Yu WU, Kaohsiung (TW)

(21) Appl. No.: 18/080,922

(22) Filed: Dec. 14, 2022

(30) Foreign Application Priority Data
Jan. 3, 2022 (TW) 111100115

(51) Int. Cl. B60K 35/00; B60L 53/66; B60L 58/10

(52) U.S. Cl. CPC B60K 35/00; B60L 53/66; B60L 58/10; B60L 2250/16; B60K 2370/16; B60K 2370/11

(57) ABSTRACT

An electric vehicle charging management system has a dashboard apparatus, a vehicle controller, and a power battery apparatus. The dashboard apparatus stores multiple charging parameters that are adjustable. The multiple charging parameters include a charging power, a charging capacity, and a charging time frame. The vehicle controller is connected to the dashboard apparatus. The vehicle controller enters a charging operation mode when receiving a wake-up signal to read the multiple charging parameters from the dashboard apparatus and output the multiple charging parameters. The power battery apparatus receives a charging power source. The power battery apparatus has a control unit and an energy storage unit. The control unit is connected to the vehicle controller. When the control unit receives the multiple charging parameters from the vehicle controller, the control unit controls the charging power source to charge the energy storage unit according to the multiple charging parameters.

### CROSS REFERENCE TO RELATED APPLICATIONS

The present application claims priority to Taiwan application No. 111100115, filed on Jan. 3, 2022, the content of which is hereby incorporated by reference in its entirety.

### BACKGROUND OF THE INVENTION

### 1. Field of the Invention

The present invention relates to a charging management system, and more particularly to an electric vehicle charging management system.

### 2. Description of Related Art

Nowadays, the electric scooters can be classified into two categories mainly based on the power battery types. A first category may be a power-battery-exchangeable electric vehicle. A second category may be a fixed-power-battery electric vehicle. For the fixed-power-battery electric vehicle, its power battery is not detachable and is not exchangeable by the user himself/herself. In general, the user can park the electric vehicle in the garage. The garage has a charging pile. Connecting the charging pile to a charging connector of the electric vehicle can directly charge its power battery.

Charging situations are closely related to the lifetime of the power battery. Power storage decline happens to the lifetime of the power battery with the cycling of charging and discharging and use time. Especially, the fixed power battery adopted for the electric vehicle would not be exchangeable. The user has to accept the result of battery power storage decline (such as reduction of cruising endurance). Hence, the user must take much care of the power battery.

If the power battery gets used to charging by a quick-charge (QC) mode for a long time, although the power battery can finish the charging in a short time, high charging current and high charging power would cause temperature increase and changes of properties of battery materials to the power battery, resulting in shortening the lifetime of the battery and causing problems such as performance decline of the electric vehicle.

On the other hand, many countries enforce time-of-use rate mechanism for electricity price. In general, higher electricity price is adopted for the peak time, and lower electricity price is adopted for the off-peak time, wherein the off-peak time is in the depth of night. As the conventional charging pile performs the charging directly upon connection to the charging connector of the electric vehicle, the general public, who wants to get the advantage of lower charging cost within the off-peak time, has to wait until depth of night to manually connect the charging pile to the electric vehicle to perform the charging, which causes difficulty of use.

### SUMMARY OF THE INVENTION

An objective of the present invention is to provide an electric vehicle charging management system with an expectation to improve the charging situation for the power battery of the electric vehicle. And the advantage of lower charging cost will be achieved more easily by time-of-use rate mechanism.

The electric vehicle charging management system of the present invention is applied to an electric vehicle and comprises:

a dashboard apparatus storing multiple charging parameters that are adjustable and include a charging power, a charging capacity, and a charging time frame;

a vehicle controller connected to the dashboard apparatus; the vehicle controller entering a charging operation mode when receiving a wake-up signal to read the multiple charging parameters from the dashboard apparatus and output the multiple charging parameters; and

a power battery apparatus receiving a charging power source; the power battery apparatus comprising a control unit and an energy storage unit; the control unit connected to the vehicle controller; wherein when the control unit receives the multiple charging parameters from the vehicle controller, the control unit controls the charging power source to charge the energy storage unit according to the multiple charging parameters.

According to the electric vehicle charging management system of the present invention, the charging power, the charging capacity, and the charging time frame of the dashboard apparatus are adjustable charging parameters. They are provided to be set by the user based on the user's needs. That is different from the conventional charging pile that performs the charging directly upon connection to the charging connector of the electric vehicle. When the power battery apparatus in the present invention is connected to the charging pile, it is charged only during the charging time frame as set, and would not be charged beyond the charging time frame. Therefore, the user can set the charging time frame within the off-peak time to have the advantage of lower charging cost. On the other hand, the user may set a proper charging power and charging capacity, without permanently enabling the quick-charge mode. By doing so, high charging current and high charging power as mentioned in the conventional art will be avoided, so as to relatively extend the lifetime of the energy storage unit of the power battery apparatus, and to ensure that the electric vehicle for a long time will still maintain a certain performance and cruising endurance.

### BRIEF DESCRIPTION OF THE DRAWINGS

FIG. 1 is a block diagram of the electric vehicle charging management system of the present invention;

FIG. 2 is a block diagram of a first embodiment of the electric vehicle charging management system of the present invention;

FIG. 3 is a block diagram of a second embodiment of the electric vehicle charging management system of the present invention;

FIG. 4 is a block diagram of a third embodiment of the electric vehicle charging management system of the present invention;

FIG. 5 is a diagram of a first charging example of the electric vehicle charging management system of the present invention; and

FIG. 6 is a diagram of a second charging example of the electric vehicle charging management system of the present invention.

### DETAILED DESCRIPTION OF PREFERRED EMBODIMENT(S)

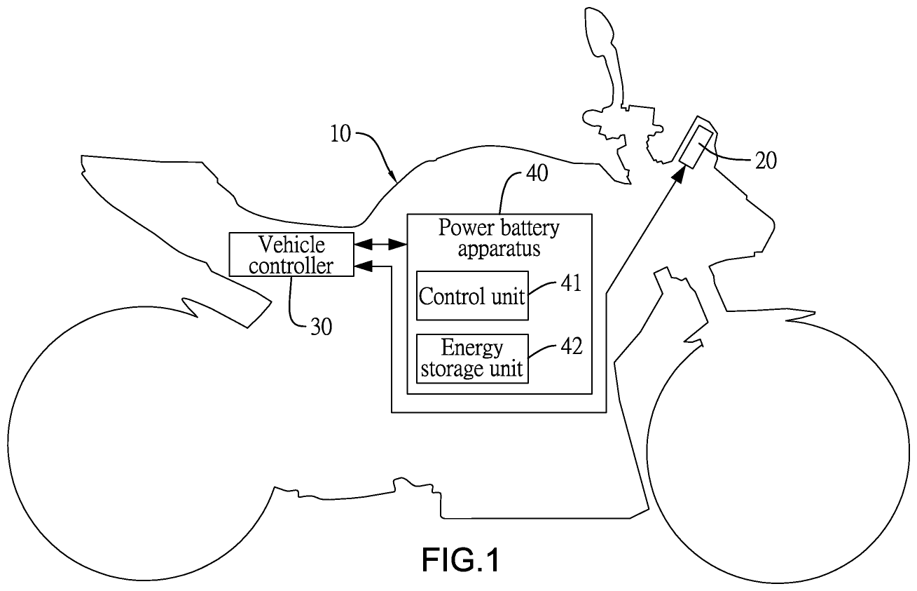

With reference to FIG. 1, the electric vehicle charging management system of the present invention is applied to an electric vehicle 10. The electric vehicle 10 may be, but is not limited to, a straddle-type electric motorcycle or a common scooter-type electric scooter. The electric vehicle charging management system of the present invention comprises a dashboard apparatus 20, a vehicle controller (VCU) 30, and a power battery apparatus 40. The dashboard apparatus 20, the vehicle controller 30, and the power battery apparatus 40 are mounted on a vehicle body.

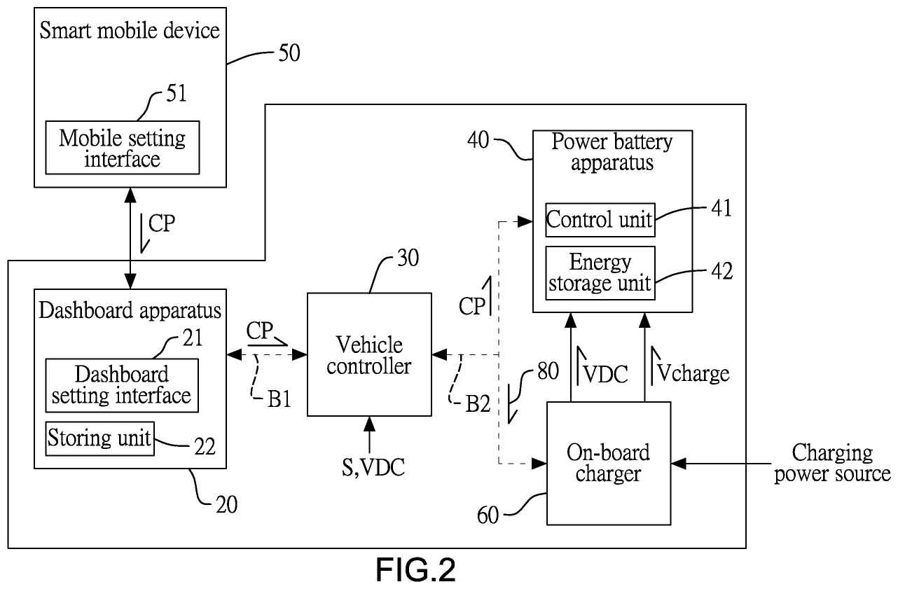

The dashboard apparatus 20 stores multiple adjustable charging parameters. The multiple charging parameters include a charging power, a charging capacity, and a charging time frame, namely, the charging time frame corresponds to the charging power and the charging capacity. Wherein, with reference to FIGS. 2-4, the dashboard apparatus 20 may have a storing unit 22. The storing unit 22 may be a memory or a memory card, so is capable of storing data of the multiple charging parameters CP. Regarding the manner of the dashboard apparatus 20 to obtain the multiple charging parameters CP, with reference to FIGS. 2-4, the dashboard apparatus 20 is provided to communicate with a smart mobile device 50. The smart mobile device 50 may be a smart phone or a tablet computer, which provides a mobile setting interface 51. The mobile setting interface 51 is a graphical user interface (GUI) provided for the user to set the multiple charging parameters CP. By doing so, the dashboard apparatus 20 may receive and store the multiple charging parameters CP from the smart mobile device 50. Wherein, the dashboard apparatus 20 and the smart mobile device 50 wirelessly communicate with each other via wireless communication protocol such as Wi-Fi, Bluetooth, and so on. Or, the dashboard apparatus 20 may comprise a dashboard setting interface 21. For example, the dashboard setting interface 21 may be displayed via a monitor or a touch screen monitor. The dashboard setting interface 21 may be a graphical user interface (GUI) to set the multiple charging parameters CP according to user's operation, and can further store the multiple charging parameters CP in the storing unit 22.

It should be explained that the mobile setting interface 51 and the dashboard setting interface 21 as mentioned above have input fields of the multiple charging parameters CP (such as the charging power, the charging capacity, and the charging time frame) for the user to set up. The dashboard apparatus 20 obtains the multiple charging parameters CP via one of the mobile setting interface 51 and the dashboard setting interface 21. The present invention may have the mobile setting interface 51 as well as the dashboard setting interface 21 for the user to use.

The vehicle controller 30 is connected to the dashboard apparatus 20. The vehicle controller 30 enters a charging operation mode when receiving a wake-up signal S. When the vehicle controller 30 operates at the charging operation mode, the vehicle controller 30 reads the multiple charging parameters CP and outputs the multiple charging parameters CP. For example, after the user parks the electric vehicle 10 and turns it off, the vehicle controller 30 is in a shutdown state or a standby (hibernate) state. Under such state, when the vehicle controller 30 receives the wake-up signal S, the vehicle controller 30 then can enter the charging operation mode from the shutdown state or the standby (hibernate) state.

The power battery apparatus 40 is provided to be connected to a power apparatus to receive a charging power source. The power apparatus may be a charging pile as an example, such that the charging power source may be a utility alternating-current power source outputted by the charging pile. Its substantial embodiments will be described as follows. The power battery apparatus 40 comprises a control unit 41 and an energy storage unit 42. The control unit 41 may be a processor chip of a battery management system (BMS) and has functions of data computing, control, and transmission. The control unit 41 is connected to the vehicle controller 30. The energy storage unit 42 may be a rechargeable battery. The control unit 41 is connected to the energy storage unit 42 and may monitor a power storage capacity of the energy storage unit 42. When the control unit 41 receives the multiple charging parameters CP from the vehicle controller 30, the control unit 41 controls a charging condition of the charging power source to charge the energy storage unit 42 according to the multiple charging parameters CP (such as the charging power, the charging capacity, and the charging time frame).

In general, when the dashboard apparatus 20, the vehicle controller 30, and the control unit 41 are in the shutdown state or the standby (hibernate) state, they can still obtain a standby power source from the power battery apparatus 40 to maintain a standby fundamental operation, so the charging parameters CP stored in the dashboard apparatus 20 are readable. Besides, when the dashboard apparatus 20, the vehicle controller 30, and the control unit 41 are in a powered-on (vehicle driving) state, they can receive a working power source from the power battery apparatus 40.

With reference to FIG. 2, in a first embodiment of the present invention, the electric vehicle 10 is a high-end model. The electric vehicle charging management system further comprises an on-board charger (OBC) 60. In general, the on-board charger 60 comprises control chip(s) and has functions of data computing, control, and transmission. The on-board charger 60 is an alternating-current to direct-current (AC to DC) converter having an AC input terminal and a DC output terminal, wherein the AC input terminal is provided to be connected to an off-board charger. The off-board charger may be the charger pile as an example, such as an electric vehicle supply equipment (EVSE), to receive the charging power source. Hence, the power battery apparatus 40 receives the charging power source via the on-board charger 60. The DC output terminal of the on-board charger 60 is connected to the vehicle controller 30 and the control unit 41 of the power battery apparatus 40 respectively via trigger power wires (such as substantial cables), and is connected to the energy storage unit 42 of the power battery apparatus 40 via charging power wires (such as substantial cables). The vehicle controller 30 is connected to the dashboard apparatus 20 via a first data bus B1. The control unit 41 of the power battery apparatus 40 is connected to the vehicle controller 30 and the on-board charger 60 via a second data bus B2. Wherein, the first data bus B1 and the second data bus B2 may be, but are not limited to, a controller area network bus (CAN Bus).

According to the above-mentioned configuration, the on-board charger 60 can convert the charging power source to a DC power source, and then output a direct-current voltage VDC to the vehicle controller 30 and the control unit 41 of the power battery apparatus 40. The on-board charger 60 also outputs a direct-current charging power source Vcharge to the energy storage unit 42 to charge it. The dashboard apparatus 20 and the vehicle controller 30 perform data transmission via the first data bus B 1. The vehicle controller 30, the power battery apparatus 40, and the on-board charger 60 perform data transmission via the second data bus B2.

After the user parks the electric vehicle 10 and turns it off, the on-board charger 60 is not connected to the off-board charger yet and does not output the direct-current voltage VDC yet, so the vehicle controller 30 is in a shutdown state or a standby (hibernate) state. When the on-board charger 60 is connected to the off-board charger, the on-board charger 60 can receive the charging power source. At that time, the on-board charger 60 is activated to perform AC to DC power conversion, and outputs the direct-current voltage VDC to the vehicle controller 30 and the power battery apparatus 40 via the trigger power wires to wake them up. Namely, the direct-current voltage VDC is deemed as the wake-up signal S of the vehicle controller 30. At that time, the vehicle controller 30 enters the charging operation mode according to the wake-up signal S to receive the multiple charging parameters CP from the dashboard apparatus 20 via the first data bus B1, and to output the multiple charging parameters CP to the control unit 41 of the power battery apparatus 40 via the second data bus B2 by broadcasting. The control unit 41 then can output control commands 80 to the on-board charger 60 according to the multiple charging parameters CP via the second data bus B2, such that the charging power source is converted to the direct-current charging power source Vcharge by the on-board charger 60 to charge the energy storage unit 42. Its substantial instance will be described as follows.

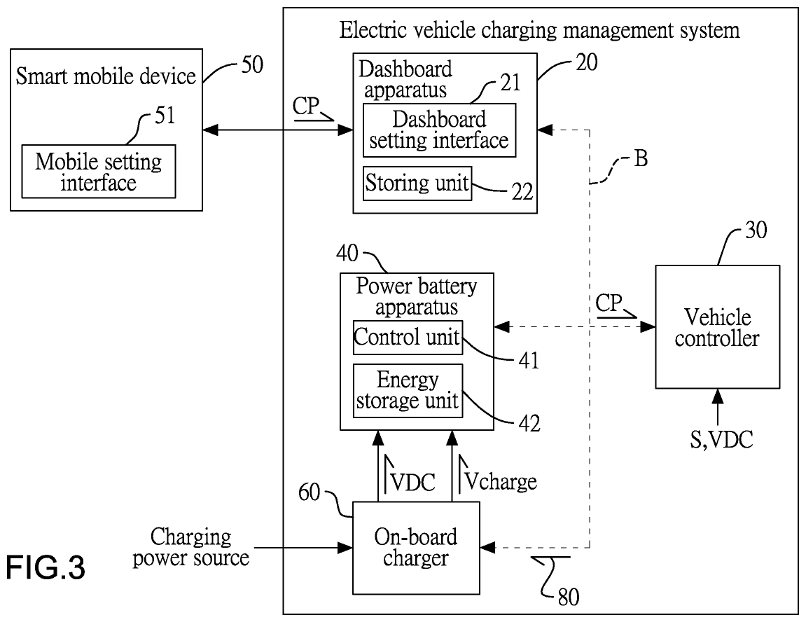

With reference to FIG. 3, in a second embodiment of the present invention, the electric vehicle 10 is a lower-end model. The electric vehicle charging management system also comprises the above-mentioned on-board charger 60. Its function may refer to the first embodiment and is not repeatedly described herein. The difference between the second embodiment and the first embodiment is that the vehicle controller 30 of the second embodiment is connected to the dashboard apparatus 20, the control unit 41 of the power battery apparatus 40, and the on-board charger 60 via a data bus B. The data bus B may be, but is not limited to, the controller area network bus (CAN Bus).

In the second embodiment, when the on-board charger 60 is connected to the off-board charger, the on-board charger 60 can receive the charging power source. And then the on-board charger 60 is activated to perform AC to DC power conversion, and so outputs the direct-current voltage VDC to the vehicle controller 30 and the control unit 41 of the power battery apparatus 40 to wake them up. Namely, the direct-current voltage VDC is deemed as the wake-up signal S of the vehicle controller 30. At that time, the vehicle controller 30 enters the charging operation mode according to the wake-up signal S to receive the multiple charging parameters CP from the dashboard apparatus 20 via the data bus B, and to output the multiple charging parameters CP to the control unit 41 of the power battery apparatus 40 via the data bus B by broadcasting. The control unit 41 then can output control commands 80 to the on-board charger 60 according to the multiple charging parameters CP via the data bus B, such that the charging power source is converted to the direct-current charging power source Vcharge by the on-board charger 60 to charge the energy storage unit 42. Its substantial instance will be described as follows.

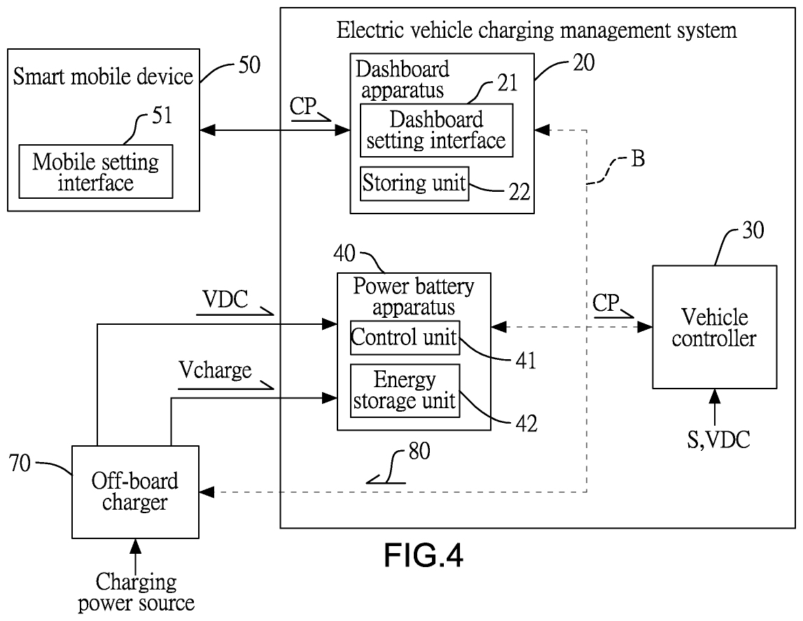

With reference to FIG. 4, in a third embodiment of the present invention, the electric vehicle 10 is a low-power compact model. The electric vehicle charging management system is applied to be connected to an off-board charger 70. The off-board charger 70 may comprise control chip(s), such as an electric vehicle communication controller (EVCC), and has functions of data computing, control, and transmission. The off-board charger 70 is an alternating-current to direct-current (AC to DC) converter having an AC input terminal and a DC output terminal, wherein the AC input terminal may be connected to a utility power socket to receive the charging power source. The DC output terminal of the off-board charger 70 is connected to the vehicle controller 30 and the control unit 41 of the power battery apparatus 40 respectively via trigger power wires (such as substantial cables), and is connected to the energy storage unit 42 of the power battery apparatus 40 via charging power wires (such as substantial cables). The vehicle controller 30 is connected to the dashboard apparatus 20, the control unit 41 of the power battery apparatus 40, and the off-board charger 70 via a data bus B for performing data transmission. Compared with the first embodiment and the second embodiment, the third embodiment is not equipped with the above-mentioned on-board charger 60 to relatively reduce its whole volume and may be adapted for low-power and compact electric vehicle model.

After the user parks the electric vehicle 10 and turns it off, it is not connected to the off-board charger 70 yet, so the vehicle controller 30 is in a shutdown state or a standby (hibernate) state, and the vehicle controller 30 does not receive the direct-current voltage VDC. When the electric vehicle charging management system of the present invention is connected to the off-board charger 70, the off-board charger 70 is activated to perform AC to DC power conversion, and so outputs the direct-current voltage VDC. The vehicle controller 30 and the power battery apparatus 40 receive the direct-current voltage VDC from the off-board charger 70 via the trigger power wires. Namely, the direct-current voltage VDC is deemed as the wake-up signal S of the vehicle controller 30. At that time, the vehicle controller 30 operates at the charging operation mode to receive the multiple charging parameters CP from the dashboard apparatus 20 via the data bus B, and to output the multiple charging parameters CP to the control unit 41 of the power battery apparatus 40 via the data bus B by broadcasting. The control unit 41 then can output control commands 80 to the off-board charger 70 according to the multiple charging parameters CP via the data bus B, such that the charging power source is converted to the direct-current charging power source Vcharge by the off-board charger 70 to charge the energy storage unit 42. Its substantial instance will be described as follows.

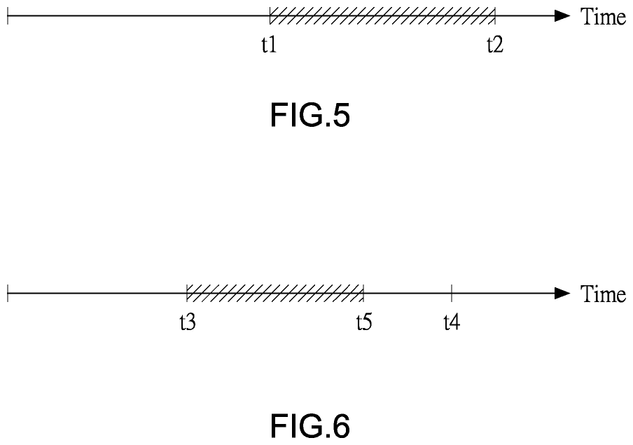

Regarding the manner of controlling the charging power source to charge the energy storage unit 42 in the first to third embodiments of the present invention, as mentioned above, the multiple charging parameters CP include the charging power, the charging capacity, and the charging time frame. For example, the parameter of the charging power may be set as 200 W, the parameter of the charging capacity may be set as 100%, and the parameter of the charging time frame may be set as shown in FIG. 5, which includes a charging-time-frame start point t1 and a charging-time-frame end point t2. Data format of t1 and t2 may be “year-month-day-hour-minute” as an example. Accordingly, the vehicle controller 30 has a clock unit (real-time clock) to generate a host-vehicle real time, and determines whether the host-vehicle real time is within t1 and t2. If yes, the present invention can begin the charging from the charging-time-frame start point t1 to charge the energy storage unit 42 by the direct-current charging power source Vcharge of 200 W power, and terminate the charging when reaching the charging-time-frame end point t2. Besides, with reference to FIG. 6. after the charging-time-frame start point t3 and before reaching the charging-time-frame end point t4, the control unit 41 detects that the power storage capacity of the energy storage unit 42 reaches the 100% as set at the time point t5, and the control unit 41 can control the on-board charger 60 or the off-board charger 70 to temporarily stop charging.

In conclusion, the technical effects of the present invention are as follows:

1. The dashboard apparatus 20 in the present invention has the dashboard setting interface 21 for the user to freely set the charging parameters including the charging power, the charging capacity, and the charging time frame.

2. During a time with a higher electrical load in the user's home (e.g., under the situation that the electric stove and the electric water heater are in use), the user can set a lower charging power for that time to prevent the no-fuse breakers (NFB) in the home electrical grid from tripping due to over loading. On the other hand, the user can freely select a safe and proper charging power corresponding to different power consumption situations. The lifetime of the energy storage unit 42 can be relatively extended by setting a lower charging power. A higher charging power may reduce the time to charge for the user to complete the power supplement within a short time and get on the road fast.

3. When the energy storage unit 42 operates at a very low power capacity (about less than 30%) or a higher power capacity (about higher than 80%), the lifetime of the battery as a whole will be shortened due to the properties of the battery materials. If the user does not have a demand for long cruising endurance at a moment using the electric vehicle, the user may freely set the charging capacity as a proper value, so as to prevent the energy storage unit 42 from reduction of its lifetime arising from excessively extreme power capacity.

4. The user may set the charging time frame and the charging power via the dashboard setting interface 21 of the dashboard apparatus 20. For example, a lower charging power can be set during rush hours of usage of the household appliances with an expectation to reduce the loading of the electrical grid. Or, a higher charging power can be set during a time with low electricity price to reduce the cost and time for charging.

5. Each one of the above-mentioned charging parameters (such as the charging power, the charging capacity, and the charging time frame) can be adjusted via the dashboard setting interface 21 of the dashboard 20, or via the mobile setting interface 51 of the smart mobile device 50 while executing an application (APP) and communicating with the dashboard apparatus 20. Hence, the user can implement such setting remotely and has no need to be near the vehicle.

What is claimed is:

1. An electric vehicle charging management system applied to an electric vehicle and comprising:
a dashboard apparatus storing multiple charging parameters that are adjustable and include a charging power, a charging capacity, and a charging time frame;
a vehicle controller connected to the dashboard apparatus; the vehicle controller entering a charging operation mode when receiving a wake-up signal to read the multiple charging parameters from the dashboard apparatus and output the multiple charging parameters; and
a power battery apparatus receiving a charging power source; the power battery apparatus comprising a control unit and an energy storage unit; the control unit connected to the vehicle controller; wherein when the control unit receives the multiple charging parameters from the vehicle controller, the control unit controls the charging power source to charge the energy storage unit according to the multiple charging parameters.

2. The electric vehicle charging management system as claimed in claim 1, wherein the dashboard apparatus is provided to wirelessly communicate with a smart mobile device to receive and store the multiple charging parameters from the smart mobile device.

3. The electric vehicle charging management system as claimed in claim 1, wherein the dashboard apparatus comprises a dashboard setting interface, and the dashboard setting interface sets the multiple charging parameters according to user's operation.

4. The electric vehicle charging management system as claimed in claim 2, wherein the dashboard apparatus comprises a dashboard setting interface, and the dashboard setting interface sets the multiple charging parameters according to user's operation.

5. The electric vehicle charging management system as claimed in claim 1 further comprising an on-board charger; the on-board charger respectively connected to the vehicle controller and the power battery apparatus via trigger power wires; the power battery apparatus receiving the charging power source via the on-board charger; wherein:
the vehicle controller is connected to the dashboard apparatus via a first data bus, and the control unit of the power battery apparatus is connected to the vehicle controller and the on-board charger via a second data bus;
when the on-board charger receives the charging power source, the on-board charger outputs a direct-current voltage to the vehicle controller and the power battery apparatus via the trigger power wires, wherein the direct-current voltage is the wake-up signal for the vehicle controller;
the vehicle controller receives the multiple charging parameters from the dashboard apparatus via the first data bus, and outputs the multiple charging parameters to the control unit of the power battery apparatus via the second data bus by broadcasting;
the control unit of the power battery apparatus outputs control commands to the on-board charger according to the multiple charging parameters via the second data bus, so as to control the charging power source to charge the energy storage unit via the on-board charger.

6. The electric vehicle charging management system as claimed in claim 1 further comprising an on-board charger; the on-board charger respectively connected to the vehicle controller and the power battery apparatus via trigger power wires; the power battery apparatus receiving the charging power source via the on-board charger; wherein:
the vehicle controller is connected to the dashboard apparatus, the control unit of the power battery apparatus, and the on-board charger via a data bus;
when the on-board charger receives the charging power source, the on-board charger outputs a direct-current voltage to the vehicle controller and the power battery apparatus via the trigger power wires, wherein the direct-current voltage is the wake-up signal for the vehicle controller;
the vehicle controller receives the multiple charging parameters from the dashboard apparatus via the data bus, and outputs the multiple charging parameters to the control unit of the power battery apparatus via the data bus by broadcasting;
the control unit of the power battery apparatus outputs control commands to the on-board charger according to the multiple charging parameters via the data bus, so as to control the charging power source to charge the energy storage unit via the on-board charger.

7. The electric vehicle charging management system as claimed in claim 1 applied to be connected to an off-board charger; the off-board charger respectively connected to the vehicle controller and the power battery apparatus via trigger power wires; the power battery apparatus receiving the charging power source via the off-board charger; wherein:
the vehicle controller is connected to the dashboard apparatus, the control unit of the power battery apparatus, and the off-board charger via a data bus;
the vehicle controller and the power battery apparatus receive a direct-current voltage from the off-board charger via the trigger power wires, wherein the direct-current voltage is the wake-up signal for the vehicle controller;
the vehicle controller receives the multiple charging parameters from the dashboard apparatus via the data bus, and outputs the multiple charging parameters to the control unit of the power battery apparatus via the data bus by broadcasting;
the control unit of the power battery apparatus outputs control commands to the off-board charger according to the multiple charging parameters via the data bus, so as to control the charging power source to charge the energy storage unit via the off-board charger.

8. The electric vehicle charging management system as claimed in claim 2, wherein the smart mobile device provides a mobile setting interface, and the mobile setting interface is a graphical user interface having multiple input fields of the multiple charging parameters.

9. The electric vehicle charging management system as claimed in claim 3, wherein the dashboard setting interface is a graphical user interface having multiple input fields of the multiple charging parameters.

10. The electric vehicle charging management system as claimed in claim 4, wherein the dashboard setting interface is a graphical user interface having multiple input fields of the multiple charging parameters.

11. The electric vehicle charging management system as claimed in claim 1, wherein the charging time frame includes a charging-time-frame start point and a charging-time-frame end point.

12. The electric vehicle charging management system as claimed in claim 11, wherein data format of the charging-time-frame start point and the charging-time-frame end point is year-month-day-hour-minute.
